(19) United States
(12) Patent Application Publication
(10) Pub. No.: US 2004/0202920 A1
(43) Pub. Date: Oct. 14, 2004

(54) Cermet electrode and a method of manufacturing the same

(75) Inventors: Masamichi Ipponmatsu, Nishinomiya-shi (JP); Minoru Suzuki, Osaka (JP); Hirokazu Sasaki, Toyonaka (JP); Shoji Otoshi, Sakai (JP)

Correspondence Address: JORDAN AND HAMBURG LLP, 122 EAST 42ND STREET, SUITE 4000, NEW YORK, NY, 10168, US

(73) Assignee: Osaka Gas Company Limited, Osaka-shi (JP)

(21) Appl. No.: 10/836,510

(22) Filed: Apr. 29, 2004

Related U.S. Application Data
(63) Continuation of application No. 10/005,588, filed on Oct. 29, 2001, now abandoned.
Application No. 10/005,588 is a continuation of application No. 08/864,437, filed on May 28, 1997, now abandoned.
Application No. 08/864,437 is a continuation of application No. 08/611,835, filed on Mar. 6, 1996, now abandoned.
Application No. 08/611,835 is a continuation of application No. 08/378,992, filed on Jan. 26, 1995, now abandoned.
Application No. 08/378,992 is a continuation of application No. 07/909,900, filed on Jul. 7, 1992, now abandoned.

(30) Foreign Application Priority Data
Aug. 6, 1991 (JP) 3-196851

(51) Int. Cl. H01M 4/90

(52) U.S. Cl. 429/44

(57) ABSTRACT

The invention relates to a cermet electrode for use as e.g. the fuel electrode of a solid electrolyte fuel cell and a method of manufacturing the same. This cermet electrode is characterized by comprising grains of a high-melting metal having a melting point of not less than 1,900° C. and/or grains of an alloy containing the high-melting metal and secured in position by zirconia doped to present the form of a cubic lattice. The method of manufacturing this cermet electrode comprises covering a support of doped zirconia with grains of a high-melting metal having a melting point of not less than 1,900° C. and/or grains of an alloy containing the high-melting metal and causing a framework structure to grow from the doped zirconia around the grains by electrochemical vapor deposition to secure the grains in position and to the support.

### BACKGROUND OF THE INVENTION

This invention relates to a cermet electrode for use as e.g. the fuel electrode of a solid electrolyte fuel cell, and to a method of manufacturing the same.

A cermet electrode comprising grains of at least one of nickel, cobalt, iron and their alloys in which a framework structure of doped zirconia has been grown by electrochemical vapor deposition (e.g. Japanese Kokai Patent Publication Nos. 62-296366 and 62-281271), as well as a method for manufacturing such an electrode, are already known.

However, since the operating temperature of a solid electrolyte fuel cell is as high as about 1,000° C., any cermet electrode incorporating nickel, cobalt or iron experiences sintering of the metal grains in the passage of a large current (not less than 2A/cm²) or in long-term use, which leads to shrinkage and a decrease in reactive surface area, resulting in aging of performance.

To obviate the above disadvantage, it may be contemplated to manufacture a cermet electrode of improved life and electrode activity by employing a high-melting metal having a melting point of not less than 1,900° C., such as ruthenium, but since such a high-melting metal is poor in sinterability, any cermet electrode sintered at a temperature up to 1,200° C. has the drawback of low electrical conductivity in planar (crosswise) direction.

### SUMMARY OF THE INVENTION

The object of this invention is to provide a cermet electrode which is satisfactory not only in useful life and electrode activity but also in electrical conductivity and a method for manufacturing the same.

The cermet electrode of this invention comprises grains of a high-melting metal element with a melting point of not less than 1,900° C. and/or grains of an alloy containing said high-melting metal as secured by zirconia doped to present the form of a cubic lattice.

The high-melting metal and the alloy containing said high-melting metal is so resistant to sintering that the aging of performance due to sintering can be completely inhibited to insure satisfactory useful life and electrode activity. Moreover, because grains of the high-melting metal and/or its alloy are secured in position by zirconia doped to present the form of a cubic grating, the bond between the grains and the zirconia is improved to provide an increased ternary interfacial dimension contributory to electrode reaction and reduce polarizations.

The high-melting metal is preferably at least one member selected from the group consisting of ruthenium (Ru, m.p. 2,500° C.), osmium (Os, m.p. 2,700° C.), rhodium (Rh, m.p. 1,960° C.), iridium (Ir, m.p. 2,443° C.), molybdenum (Mo, m.p. 2,615° C.) and tungsten (W, m.p ca. 3,380° C.). Among them, ruthenium is particularly beneficial in terms of stability in a reducing atmosphere and cost.

Preferred species of the metal forming said alloy with such a high-melting metal are nickel, iron and cobalt.

While zirconia can be doped with yttria, calcia, ytterbia, scandium oxide or the like, yttria-doped zirconia is preferred.

In the manufacture of a cermet electrode of the invention, grains of a high-melting metal having a melting point of not less than 1,900° C. and/or grains of an alloy containing said high-melting metal are disposed over a support such as a doped zirconia electrolyte and a framework structure of doped zirconia is caused to grow around said grains by electrochemical vapor deposition to secure said grains in position and to said support.

In the electrochemical vapor deposition process, a gas-phase migration of atoms of the high-melting metal occurs through the vapor of the high-melting metal chloride formed on exposure to the vapor of a chloride, such as zirconium chloride, or a chlorine-containing atmosphere, whereby the growth of necks between the grains of said high-melting metal and/or alloy thereof is promoted to improve the electrical conductivity in planar (crosswise) direction of the cermet electrode.

The grains of said high-melting metal or alloy thereof are preferably grains with an average diameter of not greater than 10 μm. The use of nickel, cobalt or iron in the conventional technology tends to cause sintering and, therefore, the grain size cannot be reduced much. In accordance with this invention, it is possible to employ grains having an average diameter of not greater than 10 μm and, thus, insure a large reaction interface and, hence, an electrode having increased electrode reaction activity.

The cermet electrode of this invention is very satisfactory not only in useful life and electrode activity but also in electrical conductivity. Therefore, when the cermet electrode is operated as a fuel electrode in a solid electrolyte fuel cell, the internal resistance of the fuel cell is decreased and the generated current is increased in density. Moreover, because there is no sacrifice of performance due to sintering, the electrode withstands high-output operation and promises a long serviceable life.

Since the electrochemical vapor deposition technique is utilized in the manufacturing method of this invention, there occurs a gas-phase migration of atoms of the high-melting metal through the vapor of the high-melting metal chloride formed upon exposure to the vapor of a chloride, such as zirconium chloride, or a chlorine-containing atmosphere, with the result that the growth of necks occurs between grains of the high-melting metal and/or its alloy to improve the electrical conductivity in planar (crosswise) direction of the cermet electrode.

### DETAILED DESCRIPTION OF THE PREFERRED EMBODIMENTS

The following working and comparative examples are intended to describe this invention in further detail and should by no means be construed as defining the scope of the invention.

### EXAMPLE 1

A porous self-supporting cylindrical air electrode, 15 mm in outer diameter and having one end closed, as formed from a strontium-doped lanthanum manganate (La_{0.81}Sr_{0.09}MnO_{3±δ}) was coated with yttria-doped zirconia (film thickness: ca. 15 μm), an electrolyte, by the electrochemical vapor deposition technique.

Then, an aqueous slurry containing a ruthenium metal powder with a grain size of 2-3 μm (ruthenium: water:polyvinyl alcohol (binder)=40:58:2, by weight) was coated on the above yttria-doped zirconia film and dried at room temperature. Then, electrochemical vapor deposition with yttria-doped zirconia was carried out in an argon (Ar) gas atmosphere containing chlorine gas, yttrium chloride (YCl₃) and zirconia chloride (ZrCl₄).

When the solid electrolyte fuel cell thus fabricated was operated with hydrogen/oxygen at 1,000° C., the generated current was 2.5 A/cm² at 0.6 V. When the endurance test was performed at a generated current of 2.5 A/cm², no voltage drop was observed at all even after 1,000 hours and rather the voltage rose by 3%. When the resistance in planar direction of the cermet electrode was measured by the 4-terminal method, the resistance value was 0.00036 Ω cm at 1,000° C.

### Comparative Example 1

Without using the electrochemical vapor deposition technique, a ruthenium metal powder and an yttria-doped zirconia powder were admixed in a mol ratio of 10:1 and the mixture was sintered at 1,000° C. to give a fuel electrode. This fuel electrode was used to fabricate a solid electrolyte fuel cell. Then, a generation experiment was carried out in the same manner as Example 1. The generated current was 830 mA/cm² at 0.6 V. The resistance in planar direction of the cermet electrode was 0.0018 Ω cm at 1,000° C.

It is apparent from Example 1 and Comparative Example 1 that the use of a ruthenium cermet electrode manufactured by the electrochemical vapor deposition technique resulted in a marked increase in generating capacity.

### EXAMPLE 2

A porous self-supporting cylindrical air electrode, 15 mm in outer diameter and having one end closed, as formed from a strontium-doped lanthanum manganate (La_{0.81}Sr_{0.09}MnO_{3±δ}) was dipped in an aqueous slurry containing an yttria-doped zirconia powder with a grain size of about 0.1 μm (polyvinyl alcohol added as a binder) and a coating film with a thickness of about 30 μm was prepared by the vacuum suction technique, followed by sintering in the air at 1,300° C.

Then, an aqueous slurry containing a ruthenium metal powder with a grain size of 2 to 3 μm (ruthenium:water:polyvinyl alcohol (binder)=40:58:2, by weight) was coated on the above yttria-doped zirconia film and dried at room temperature. Then, electrochemical vapor deposition with yttria-doped zirconia was carried out in an argon (Ar) atmosphere containing chlorine gas, yttrium chloride (YCl₃) and zirconium chloride (ZrCl₄).

When a solid electrolyte fuel cell fabricated in the above manner was operated with hydrogen/oxygen at 1,000° C., the generated current was 1.8 A/cm² at 0.6 V.

### EXAMPLE 3

The fabrication of an electrode and the power generation test were carried out in the same manner as Example 1 except that a rhodium metal powder was used in lieu of the ruthenium metal powder. The generating capacity of the fuel cell was about 2.2 A/cm² at 0.6 V. The resistance in planar direction of the cermet electrode was 0.00056 Ω cm.

### EXAMPLE 4

The fabrication of an electrode and the power generation test were performed under the same conditions as in Example 1 except that an alloy powder consisting of 70 wt. % nickel and 30 wt. % of ruthenium (average grain size: 5 μm) was used in lieu of the ruthenium metal powder. The generating capacity of the fuel cell was about 1.5 A/cm² at 0.6 V and the resistance in planar direction of the cermet electrode was 0.00031 Ω cm.

1. A cermet electrode comprising at least one of grains of a high-melting metal having a melting point not lower than 1,900° C. and grains of an alloy containing said high-melting metal, said grains having an average diameter of not larger than 10 μm and being secured in position with zirconia doped to present the form of a cubic lattice by electrochemical vapor deposition.

2-4 (Canceled)
